(19) United States
(12) Patent Application Publication
(10) Pub. No.: US 2021/0246709 A1
(43) Pub. Date: Aug. 12, 2021

(54) Gun safe assembly

(71) Applicant: Randy Monroe Dollyhigh, North Wilkesboro, NC (US)

(72) Inventor: Randy Monroe Dollyhigh, North Wilkesboro, NC (US)

(21) Appl. No.: 16/788,267

(22) Filed: Feb. 11, 2020

(51) Int. Cl. E05G 1/06; A47B 81/00; F41C 33/06

(52) U.S. Cl. CPC E05G 1/06; F41C 33/06; A47B 81/005

(57) ABSTRACT

A gun safe having one or more sliding, pivoting drawers configured to hold a series of long guns in a vertical position within the safe. Each drawer has firearm supports and a slide mechanism that allows the drawer to be moved out of the gun safe in a direction substantially perpendicular to the door opening. The drawer may be pivoted when withdrawn. This arrangement allows a user unrestricted access to any firearm stored on either side of the sliding gun drawer.

### BACKGROUND OF THE INVENTION

### 1. Field of the Invention

This invention relates to safes, and in particular, to an improved gun safe assembly.

### 2. Description of the Prior Art

The first rule of firearm safety is “proper gun control”, this rule is equally applicable when aiming and preparing to fire a weapon as it is when storing a weapon for a period of time. It is the responsibility of gun owners to secure their firearms to protect children or inexperienced adults; and to keep firearms out of the hands of criminals in the event of theft.

Cables and trigger locks are an inexpensive way to keep children safe from unattended firearm access; however criminals will simply carry the disabled firearm away and remove the lock later using cutting tools. Using a quality gun safe is by far the best solution for securing firearms. Gun safes vary allowing a user to safely store single firearms in a pistol safe which should be permanently attached to a wall or a floor, or multiple firearms may be secured within a large standup safe. Large standup safes may be configured to securely store twenty or more long guns and additional hand guns and ammunition.

Most standup safes are configured to store the long guns with the butt-stock standing on the gun safe floor and the gun barrel restrained within a padded slot formed in a barrel support rack. In some configurations butt-stock indentations are formed having the same spacing as the slots in the barrel support rack and configured to keep the long guns separated to prevent bumping and scratching the valuable and sometimes artistic firearms. Large high capacity standup gun safes will include a gun rack along the back wall and possibly the side walls of the gun safe but may also include one or more additional rows of racking positioned in front of the back wall rack. This configuration allows for effective use of the gun safe floor space but presents a problem when a user desires to remove a long gun that is stored along the back wall of the safe. In most cases it is necessary to remove all of the firearms that are stored in front of that position on the back wall rack before the back gun can be removed. In some cases the user may attempt to slide the long gun between the forward positioned firearms; which may result in damage or possible optical sight misalignment to both the gun being removed and the firearms contacted.

Accordingly, it would be desirable to provide a gun safe where all guns can be accessed without requiring the removal of any guns.

The disclosure of the present invention relates to a gun safe having one or more sliding, pivoting drawers configured to hold a series of long guns in a vertical position within the safe. Each drawer has firearm supports and a slide mechanism that allows the drawer to be moved out of the gun safe in a direction substantially perpendicular to the door opening. The drawer may be pivoted when withdrawn. This arrangement allows a user unrestricted access to any firearm stored on either side of the sliding gun drawer.

### SUMMARY OF THE INVENTION

It is a major object of the invention to provide an improved gun safe assembly.

It is another object of the invention to provide an improved gun safe assembly having sliding drawers.

It is another object of the invention to provide an improved gun safe assembly having sliding drawers for storing long guns vertically.

### BRIEF DESCRIPTION OF THE DRAWINGS

FIG. 1 depicts a side view of the gun safe assembly of the invention.

FIG. 2 shows a top view, partly in section, of the assembly of FIG. 1.

FIG. 3 shows a side view of a drawer of the gun safe assembly.

FIG. 4 shows a diagrammatic illustration of a top view of a drawer of the gun safe assembly.

### DETAILED DESCRIPTION OF THE PREFERRED EMBODIMENTS

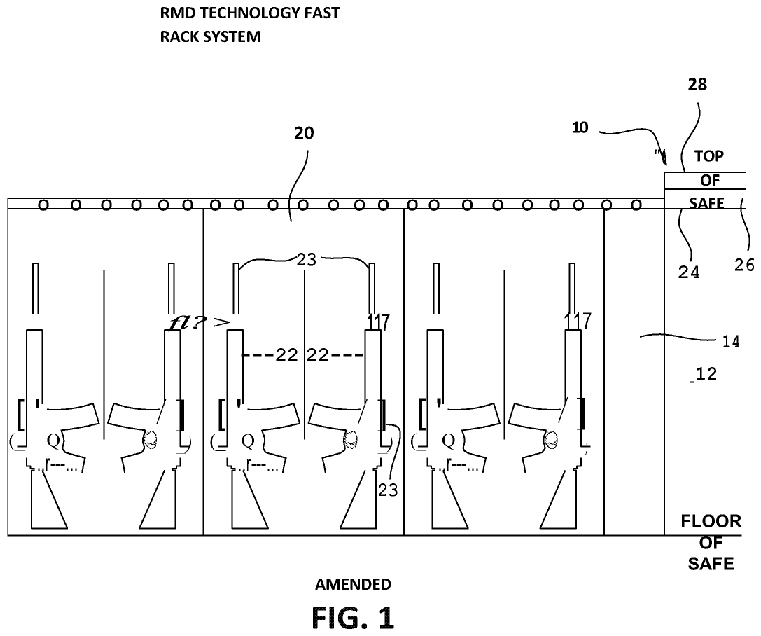

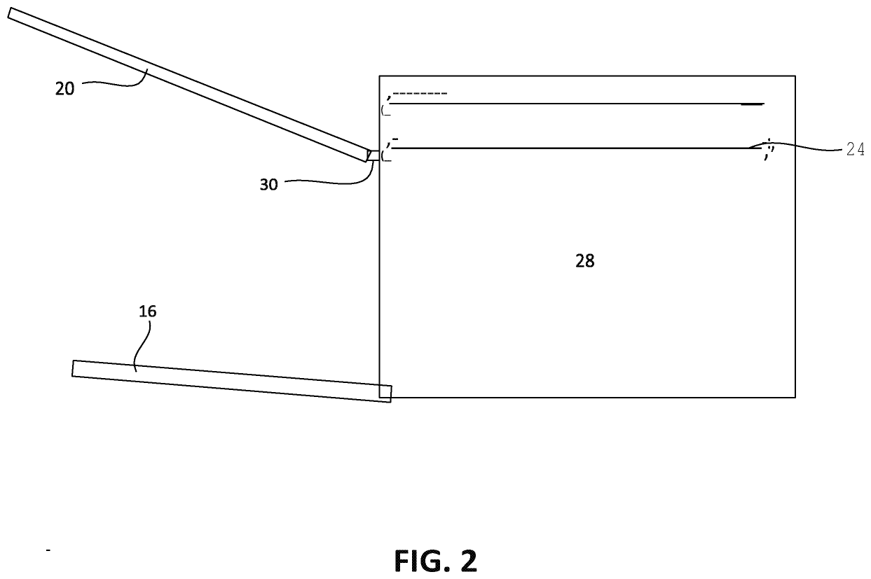

Referring now to FIGS. 1-4, the apparatus of the invention, generally indicated by the numeral 10, is shown. It can be seen that the apparatus 10 comprises a rectangular enclosure or housing 12. The housing 12 is made of metal and is reinforced in the manner of safes in general to prevent unauthorized access. The housing 12 includes an opening 14, within which a closure or door 16 is situated. The door 16 includes a latch and locking mechanism as would any safe, but the configuration of these does not form a part of the invention.

Contained within housing are several drawers 20. Each drawer 20 is vertically oriented so as to hold long guns 22 in a vertical position, and includes a pull handle 25. Each gun 22 is held vertically by at least upper and lower brackets 23, which brackets may be positioned or configured to engage or secure a trigger guard mechanism on the guns 22. Alternatively, the brackets 23 can be positioned to block access to the trigger while the gun 22 is fully seated within recess 30. This can be accomplished for different types of long guns 20 (where the vertical position of the trigger may vary) by allowing vertical adjustment of the brackets 23 as would be apparent to one of skill in the art. Specifically, brackets 23 may be secured in position by way of a flange 25 having mounting holes 27 which can be mated with corresponding mounting holes 29 formed in the drawer 20 main body 31. Alternatively, a quick release mechanism may be used in place of the vertically repositionable brackets 23 as would be apparent to one of skill in the art. Preferably, the brackets 23 allow the guns 22 to be removed by pulling from the top or barrel of the gun 22, so that any accidental discharge will go upwards and not out into the room. Each drawer 20 includes a slide assembly 24, the slide assembly including at least one horizontally disposed guide rail or track 26. The track 26 would have to be bolted or otherwise securely attached to the roof 28 of the housing 12. An additional, lower track may be added to increase the stability of the drawer 20.

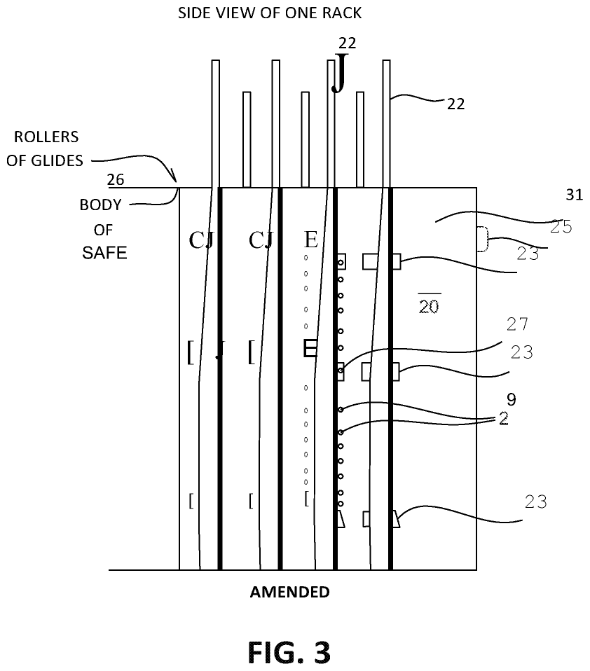

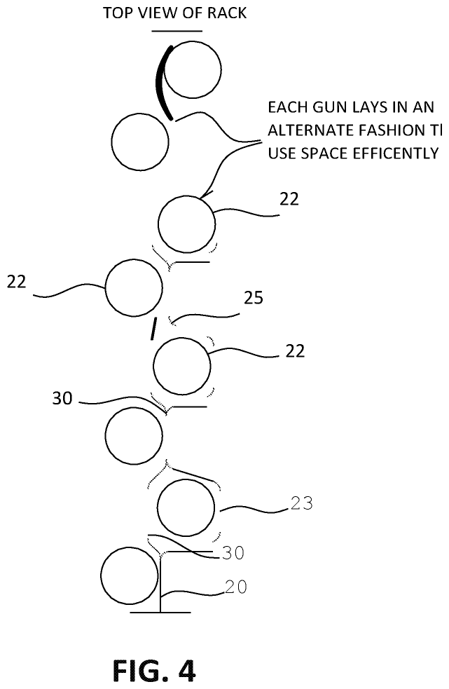

As can be seen most clearly in FIGS. 3 and 4, the guns 22 are arranged alternately on opposing sides of the drawer 20, the drawer 20 configured with alternating recesses or slots 30 for each gun 22. This arrangement minimizes the lateral space needed between drawers 20 allowing for more guns 20 to be stored.

A key aspect of the invention is the fact that the drawers 20 can be made to pivot once fully extended. To that end, a pivoting mechanism 30 is provided. The mechanism 30 allows the drawer 20 to pivot horizontally, to present the guns 22 for easy removal. It can be appreciated that by pivoting two end drawers 20 in opposite directions, and pulling one central drawer 20 straight out, more personnel can approach the safe 10 to access guns simultaneously and quickly, especially since guns 22 can be removed from either side of the drawer. This capability allows for, e.g., multiple police personnel to quickly arm themselves instead of having to go one at a time to the safe. It also allows the user to view many guns 22 at once, so that a selection may be quickly made. With prior art safes, only 2 or 3 people (at most) can approach the safe at a time, as the guns 22 cannot be deployed over a wide area as in the present invention. Alternatively, the drawers 20 may be configured without a pivoting mechanism.

It is to be understood that the present invention is not limited to the sole embodiment described above, but encompasses any and all embodiments within the scope of the following claims:

I claim:

1. A gun safe comprising, a housing, said housing having a closure pivotable between the open and closed positions;
at least one drawer mounted within said housing, said drawer slidable between fully extended and retracted positions, said at least one drawer oriented to support long guns in vertical positions;
a slide assembly associated with said at least one drawer, said slide assembly including a pivoting mechanism for pivoting said drawers.

2. The safe of claim 1 wherein there are multiple drawers.

3. The safe of claim 2 wherein each of said drawers have alternating recesses.

4. The safe of claim 3 where said alternating recesses are configured to contain said guns.

5. The safe of claim 4 wherein said recesses include brackets for securing said guns.

6. The safe of claim 5 wherein said brackets are positioned to cover triggers of said guns.

7. The safe of claim 6 wherein said brackets are vertically repositionable.
